(19) United States
(12) Patent Application Publication
(10) Pub. No.: US 2003/0221800 A1
(43) Pub. Date: Dec. 4, 2003

(54) Louver blinds

(76) Inventor: Marvin L. Jones, Tualatin, OR (US)

Correspondence Address: BRIAN C. TRASK, 3601 EAST HERMES DRIVE, SALT LAKE CITY, UT, 84124, US

(21) Appl. No.: 10/155,530

(22) Filed: May 28, 2002

(51) Int. Cl. E06B 9/30

(52) U.S. Cl. 160/168.1 R

(57) ABSTRACT

An improved window blind including one or more louver elements having a shaped edge operable to provide a decorative appearance and provide enhanced control of light transmittal while preserving privacy. The shaped edge has a portion that interfaces with a suspension harness to maintain an alignment of louvers.

### BACKGROUND

Field of the Invention

1. This invention relates to devices for controlling light passing through an architectural opening. It particularly relates to louver shades or blinds for windows, doors, and room dividers.

2. State of the Art

Conventional horizontal blinds have a plurality of louvers suspended on rungs of ladder-type structure. At least two ladder tracks are suspended from a headrail structure, which typically is capable of distorting the ladder apertures to rotate the louver elements. One or more additional ladder tracks are included in wider blinds to limit the length of unsupported louver between the tracks. Typical louvers in such conventional blinds have two or more spaced apart routing holes, each of which receives a (typically single strand) control line, or lift-cord, to provide elevation control of the bottom of the blind. The control line also serves to maintain an alignment of all the louvers, and prevents an individual louver from migrating out of the array of louvers forming the blind. The routing hole unavoidably “leaks” some light in a vertically disposed and intermittent line.

To overcome the annoying light-leaking limitation, “privacy blinds” can be made that have no mid-span routing hole. Such privacy blinds dispose one or more elevation control lines at front and/or rear edges of the louver at locations typically corresponding to the routing holes of conventional blinds. Alignment of the privacy louver elements typically is maintained by a notch in one edge of the louver that is disposed to interface with a suspension track. Engagement of the notch and track prevents side-to-side movement of the louver. Alternatively, in conventional-type louvers, a narrow band of fabric or other flexible material is sometimes placed top-to-bottom of the blind, in front of the routing hole(s), to add an additional blocking surface.

Conventional blinds are considered by some consumers to be boring or unappealing in that they have a straight bar appearance. Woodring's U.S. patent application Ser. No. 09/765,512, titled “DECORATIVE VENETIAN BLINDS” was filed Jan. 19, 2001, and discloses horizontal blinds with louvers having one edge of conventional horizontal louver elements being shaped to provide multiple shallow scallops, or other patterns, to change the appearance of the blinds from inside a room. The conventional louver elements taught in the '512 application each have the annoying route holes for lift-cords, which unavoidably leak light in a vertical interrupted line. No suggestion is made in the '512 application to form decorative edge structure operable to maintain alignment of a plurality of louver elements.

Design patents Des. 361,099; Des. 362,978; Des. 363,386; Des. 363,387; and Des. 369,265, issued to Potts, and Des. 407,935 and Des. 407,936, issued to Spektor, illustrate multiple vertical louver elements having both edges being shaped in various decorative configurations. Neither of Potts nor Spektor disclose structure to suspend louver elements in a horizontal configuration and maintain an alignment of the louvers. Litecki, in Des. 401,097 and Des. 401,098 discloses horizontal blinds having louvers with nonlinear edges. However, Litecki discloses louvers having an otherwise conventional design, with each louver having a pair of route holes in which to receive lift-cords.

Attempts have been made in certain window coverings to provide for a variation in form and pattern of transmitted light and shadow cast into a room. Variable aperture sizes may be created by a device constructed according to teachings of de Kimpe et al. in U.S. Pat. No. 6,161,607. de Kimpe et al. disclose a blind having a flexible sheet of covering material that can be tensioned to open a plurality of apertures. However, a size of the aperture openings is necessarily limited by the extent to which a covering material may be stretched in tension, among other limiting factors.

An improved decorative privacy-type louver for horizontal blinds that is capable of interfacing with suspension structure to maintain alignment of the louvers in a blind would be an improvement in the art of window coverings. A horizontal blind capable of causing a significant variation in form and pattern of transmitted light and shadow cast into a room would also be an improvement.

### BRIEF SUMMARY OF THE INVENTION

The present invention provides an improved louver apparatus operable to regulate transmission of light through an architectural opening. Such apparatus typically includes a plurality of louvers. Each of the louvers has a blocking portion and an interface portion, and can be disposed in combination substantially to cover an area to control light passing perpendicularly through the area. The apparatus generally includes a mechanism adapted to hold the louvers at their interface portion and operable to rotate the louvers between a first, a second, and a third orientation. At the first orientation, the blocking portion of the louvers blocks perpendicular transmission of light through the area. At the second orientation, at least one aperture is formed in the blocking portion between two adjacent louvers, and is disposed spaced apart from an interface portion. The aperture permits perpendicular transmission of light through a part of the blocking portion of two adjacent louvers. At the third orientation, a slot, permitting transmission of light perpendicular to the area, is formed between adjacent louvers.

Individual louvers each include first and second edges and, at the first orientation, a length of a first edge of a first louver overlaps a length of a second edge of an adjacent and complimentary louver to block perpendicular light transmission through the blocking portion or portions. The first edge of the first louver element has a nonlinear portion that is shaped, in combination with the second edge of the adjacent and complimentary louver, to form at least one aperture when the louvers are rotated to the second orientation. In certain embodiments of the invention, at the second orientation, a plurality of apertures are formed between adjacent louvers, and are spaced apart in the blocking portion. One workable louver's first edge has an undulating portion operable to form the apertures. A second workable louver includes an edge with a scalloped portion. A third workable louver includes an edge with an offset block portion. Certain embodiments of the invention may have their louvers arranged for generally vertical dependency below the holding mechanism. Other embodiments of the invention may have their louvers arranged for generally horizontal deployment below the holding mechanism.

### BRIEF DESCRIPTION OF THE DRAWINGS

In the drawings, which illustrate what are currently considered to be the best modes for carrying out the invention:

FIG. 1 is a front view in perspective of a suspended prior art horizontal blind; 1121 FIG. 2 is a rear view in perspective of one embodiment of a prior art horizontal privacy blind;

FIG. 3 is a front view in perspective of a horizontal privacy blind according to the invention;

FIG. 4 is a plan view of a prior art conventional louver element;

FIG. 5 is a plan view of a prior art privacy louver element; 1161 FIG. 6 is a plan view of a preferred privacy louver element according to the invention;

FIG. 7 is a plan view of alternative louver element construction according to the invention;

FIG. 8 is a plan view of additional alternative louver element construction according to the invention;

FIG. 9 is a side view of a portion of ladder support structure for a horizontal blind;

FIG. 10 is a side view of a portion of a horizontal blind according to the invention in a fully open position;

FIG. 11 is a side view of a portion of a horizontal blind according to the invention in a partially open position; 1221 FIG. 12 is a side view of a portion of a horizontal blind according to the invention in a substantially closed position;

FIG. 13 is a front view of a portion of a preferred horizontal blind in a fully open position;

FIG. 14 is a front view of a portion of a preferred horizontal blind in a partially open position; 1251 FIG. 15 is a front view of a portion of a preferred horizontal blind in a substantially closed position;

FIG. 16 is a front view of a preferred vertical blind; and

FIG. 17 is a view in perspective of an alternate louver for a vertical blind.

### DETAILED DESCRIPTION

A conventional horizontal blind, generally indicated at 100, is illustrated in FIG. 1. Blind 100 includes a plurality of louver elements 101, suspended in approximately parallel alignment between a head rail 102 and a ballast element 104. Left lift-cord 106 and right lift-cord 107 are typically user operated to raise and lower the ballast element 104 of the blind 100 by pulling or releasing knobs 108. Lift-cords 106 and 107, illustrated in FIG. 1, pass through apertures, or route holes 109 disposed in each louver element 101. Such lift-cords 106, 107 are also operable to maintain an alignment of the plurality of louvers 101.

Apertures 109 are sized larger than a cross-section through lift cords 106 and 107 to permit smooth action in raising and lowering the bottom ballast element 104 and individual louvers 101. Therefore, apertures 109 unavoidably produce an unoccluded space in each louver 101 through which light will pass, or leak, when the louvers 101 are rotated to a closed orientation. A blind 100 typically is closed by rotating control handle 110, which causes a corresponding distortion of ladder-type suspension tracks 112 and 114 that orients the plurality of louvers 101 in overlapping proximity.

One solution to avoid the presence of such apertures 109 is illustrated by a privacy blind, generally indicated at 120 in FIG. 2. A plurality of privacy-type louvers 124 replace the conventional louvers 101 to create a privacy blind 120. Each louver 124 typically carries interface structure, generally indicated at 126, to retain individual louvers 124 in alignment with ladder structure 112 and 114. In the embodiment illustrated in FIG. 2, the interface structure is arranged as a plurality of notches 128 disposed on the outside edge of each louver 124. Blinds 120 preferably carry such interface structure 126 disposed on the outside edge to present an uninterrupted linear louver edge on the inside (visible from the room) surface of the blind 120.

A privacy blind manufactured by Fashion Tech, of Portland, Oreg., has small, substantially rectangular notches formed by a saw cutting operation on the outside edge of louver elements. The Fashion Tech privacy louver elements have louver widths in correspondence with conventional suspension ladder structure. That is, a 2 inch privacy louver is suspended in a ladder structure sized to hold 2 inch conventional louvers. The Fashion Tech alignment notch does not cause a decrease in suspension ladder size.

In privacy blinds, such as blind 120, a single lift-cord 106 is typically replaced by a pair of lift cords disposed one inside, and one outside of the louver 124, to avoid the requirement for an aperture 109 in a louver 124. Such paired lift-cords in a privacy blind 120 are typically provided at locations corresponding to lift-cord locations for a conventional blind, such as blind 100. A single lift-cord disposed at an edge is also operable, but trends to cause a certain rotation of the louver elements when the single lift cord is actuated.

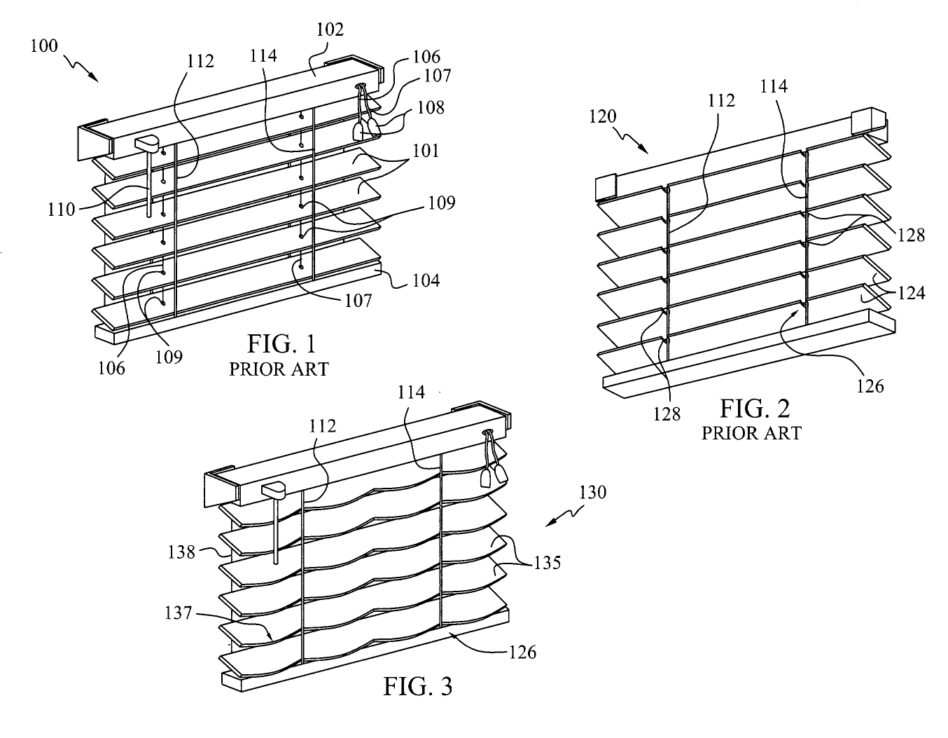

One embodiment of the invention, generally indicated at 130 in FIG. 3, provides multiple louver elements 135 having a decorative edge generally indicated at 137. Edge 137 of each louver 135 functions to maintain an alignment of the louver 135 in ladder tracks 112 and 114. It is within contemplation to include a mix of both decorative-edged and straight-edged louvers in a blind 130. Blinds incorporating one or more louvers 135 offer a pleasing visual appearance from the inside of the room. Furthermore, such blinds 130 also offer light transmission options not obtainable in conventional blinds. As will be more fully discussed below, the privacy louvers 135 and decorative edge 137 permits formation of variable-sized apertures through which light may pass, in addition to a substantially rectangular opening similar to that produced between open conventional louvers. Of course as with conventional blinds, blinds constructed according to the invention may be disposed in front of a window 138 as illustrated, or hung inside the window 138 opening.

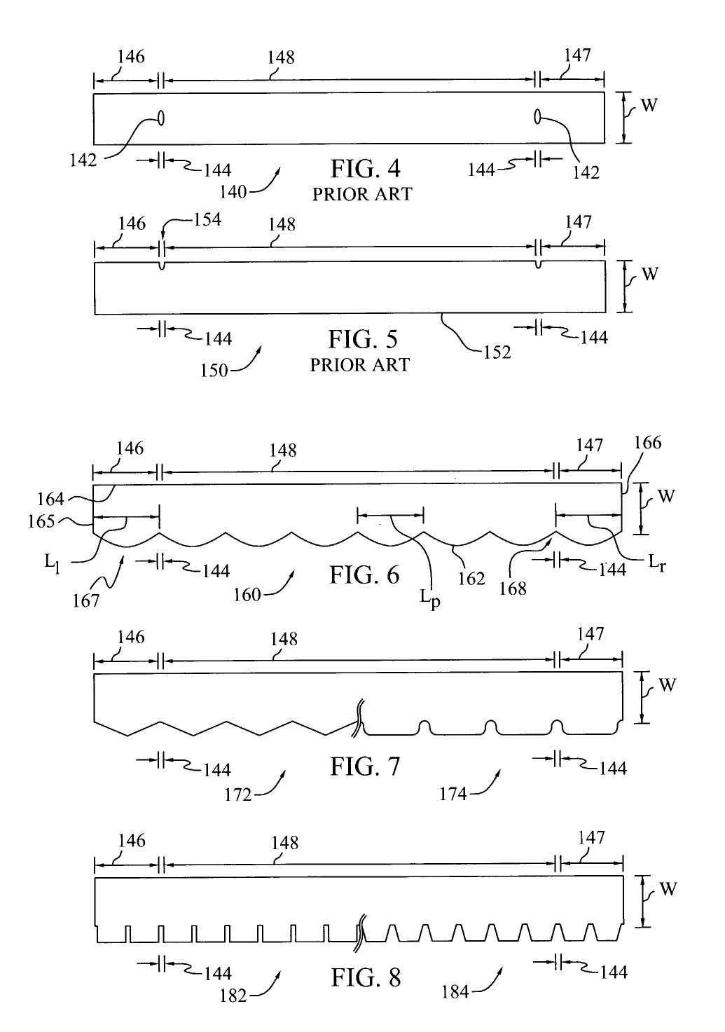

A plurality of louver elements, each structured for suspension in ladder structure of the same 2-inch nominal size and generally indicated at W, are illustrated in FIGS. 4 through 8. While louvers having a nominal 2-inch suspension size are illustrated for the convenience of relative comparison, the invention is operable in louvers having other nominal suspension sizes as well, including 1-inch and larger.

FIG. 4 illustrates a conventional louver element, generally indicated at 140. Louver 140 has a pair of routing holes 142 disposed at suspension portions 144. Louver 140 also provides a plurality of blocking portions, including left and right blocking portions 146 and 147 respectively. A single illustrated center blocking portion 148 is disposed between two suspension portions 144. In certain longer embodiments of a louver, additional center blocking portions 148 may be disposed between additional suspension portions 144.

Privacy-type horizontal louvers are illustrated in FIGS. 5-8. Such louvers also have suspension portions 144 and blocking portions 146-148. The prior art louver, generally indicated at 150 in FIG. 5, has a linear inside edge 152. Notches, generally indicated at 154, are cut into the width W of the louver 150 that is supported at suspension portions 144. Such notches 154 operate to maintain an alignment of a plurality of louvers 150 in a blind because the ladder suspension structure can sag slightly to cause an interference with the notches 154.

An exemplary, and currently preferred, louver according to the present invention is generally indicated at 160 in FIG. 6. Louver 160 has a nonlinear and decorative inside edge 162. While outside edge 164 is illustrated as being linear, it is within contemplation also for outside edge 164 to be nonlinear. It is further within contemplation for edge 164 to include one or more notches, such as a notch 154 illustrated in FIG. 5. Decorative edge structure in a louver according to the present invention, generally indicated at 167, is formed from louver material extending beyond the nominal louver suspended width W. An interface portion, generally indicated at 168, interfaces with suspension structure and helps maintain an alignment of a plurality of suspended louvers 160.

Louvers according to the invention may be described as having an inside edge 162 and an outside edge 164 between left end 165 and right end 166. The edges 162, 164 and ends 165, 166 circumscribe blocking portions 146-148 and suspension portions 144. Left and right end portions Lₗ and Lᵣ preferably are symmetric with respect to a pattern formed on inside edge 162. The pattern preferably has a repeating size based on either a multiple or fraction of Lₗ and Lᵣ to enable trimming the blinds to fit a particular window. In certain embodiments of the invention, it is preferred to premanufacture a blind with both Lₗ and Lᵣ having a length of about ½ the repeating pattern length Lₚ. For many blinds, Lₗ and Lᵣ are between about 3 and 7 inches, with a corresponding Lₚ ranging between about 3 and 14 inches. Certain preferred louvers have a pattern length Lₚ of about 7 inches. Certain preferred louvers for suspension in 2-inch ladder structure have an Lₚ of about 7 inches and an approximately circular arc pattern, such as illustrated in FIG. 6. One desirable such pattern includes arcuate sections joined together at cusp-like intersections.

FIGS. 7 and 8 illustrate louver elements having alternative decorative nonlinear inside edge structure, generally indicated at 172, 174, 182, and 184 respectively. Again, the decorative edge is formed from louver material extending beyond the supported width W. The decorative edge structure of the invention protrudes as a cantilevered lip that increases an overlap with the adjacent lower louver compared to a conventional louver, such as louver 140, or even a privacy-type louver such as louver 150. Accordingly, louver elements constructed according to the invention will form an overlapped blocking portion 148 in combination with an adjacent louver at a lesser rotation from a horizontal (or fully open) position compared to prior art louvers.

As used in this disclosure, a blocking portion 146-148 is separate and distinct from a suspension portion 144. A blocking portion 146-148 is defined as the overlappable portion formable between adjacent louver elements to form a barrier to vision perpendicular to and through the blind device. A louver's total length is the sum of the lengths of the blocking and suspension portions. Certain louvers (e.g. vertical blinds), typically will have one suspension portion 144, and one blocking portion. Other louvers (e.g. horizontal blinds), may have multiple blocking portions 146-148 and two or more suspension portions 144. In certain suspension systems, the suspension portion 144 can also function to overlap to provide a complete light-blocking overlap along the entire length of the louver. However, the suspension portion 144 remains distinguishable over a blocking portion 146-148.

A suspension portion 144 is defined as that portion of the louver adapted to interface with the suspension element (or elements) of the suspension mechanism. A suspension portion 144 generally has a length that is equal to a diameter or width of suspension structure, such as a rung of a suspension track, plus an additional length for clearance. Suspension portions 144 desirably provide alignment structure operable to form a structural interference with the suspension element(s) to resist movement of a louver from alignment with other louvers in a blind. One exemplary suspension portion 144 is created at a louver section having a reduced width W compared to the maximum louver width. Such a reduced width W typically is sized in accordance with the length of suspension elements, such as a rung 192 of a conventional ladder-type louver suspension system 190 in a horizontal blind. Suitably shaped louver elements, according to the invention, offer a dimensional change in width at, or near, an interface portion 168 operable to form a structural interference with suspension structure 190. An interface portion, such as 168 in FIG. 6, typically includes an edge portion of at least one edge at a suspension portion 144 location.

In general, suspension structure 190 relates to any structure operable to control the orientation or location of a louver relative to mounting structure of a blind. The phrase “whereby to maintain an alignment of a louver in a suspension structure” means that under normal use (e.g. suspended in front of a window), the louver elements are restrained from wandering out of alignment. A structural interference is created between louver edge structure and suspension structure to resist moving the individual louvers out of alignment. No routing hole is required, and therefore that annoying aperture is eliminated in embodiments of the invention.

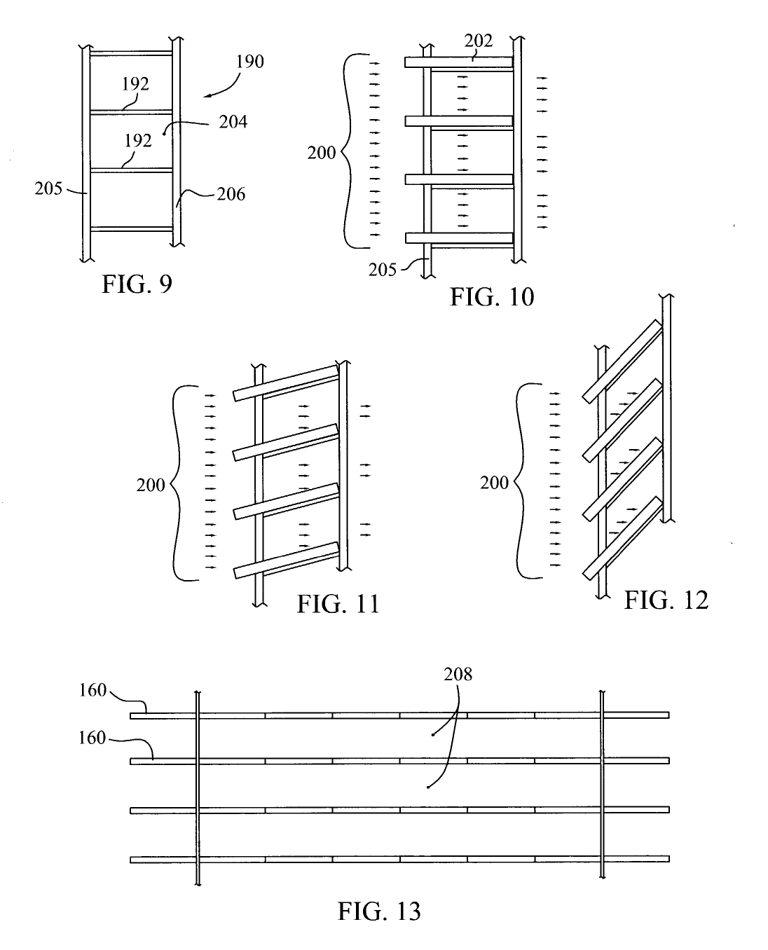

With reference to FIG. 9, it should be noted that, in general, the louver elements according to the invention can be removed from a suspension ladder of at least certain horizontal blinds by orienting such louvers on a diagonal with respect to the louver suspension box 204 formed between two adjacent rungs 192 and front rail 205 and rear rail 206. In fact, such louver positioning is utilized in the preferred assembly technique to manufacture blinds with the improved louvers according to the instant invention. However, during normal operation, the louvers are disposed in contact with a supporting rung 192, and do not tip to a diagonal position with respect to the louver suspension box 204.

Retaining interfaces 168 for privacy-type louvers are defined as structure carried by a louver and operable to maintain alignment of a louver with respect to suspension structure; typically ladder structure 190 in the case of horizontal blinds. Privacy-type louvers, such as illustrated in FIGS. 5 through 8, are defined as louvers without routing holes for lift-cords, and which leak light through nonoverlapped portions of a closed blind. For a privacy-type louver according to the instant invention, retaining interfaces 168 are formed strictly from the shape of at least one louver edge, at a location in proximity to suspension structure. In particular, no apertures are formed through the privacy-type louver in which to accommodate suspension structure such as elevation control cords. Any elevation control cords are disposed outboard of one or both edges of a privacy-type louver. In general, a ladder rail 205, 206 or rung 192 structurally interferes with a retaining interface of a privacy-type louver to resist migration of the louver away from an alignment with the ladder structure 190. 1451 Ladder-type suspension tracks, such as generally indicated at 190 in FIG. 9, are commercially available having rungs 192 sized to accomodate louvers having 1, 1½, 2, and more recently, 2½ inch suspension widths. A privacy-type louver, according to the invention, can be manufactured by forming an appropriate edge shape in a louver having a maximum width about ½ inch larger than a rung size of the suspension track. That is, a louver with a maximum width of about 2½ inches desirably will have a nonlinear edge shaped to accomodate reception of the louver in a 2 inch ladder-type suspension track.

In general, oversizing the maximum louver width compared to the length of a suspension track rung 192 can help to create a desired interference between suspension structure of the track and interface structure 168 carried on one or more edges of the improved privacy-type louver. Furthermore, the oversized width of the improved louver permits formation of decorative edge structure in that extra width portion, while producing an overlap section between adjacent louvers at least equal in size to that overlap provided by conventional louvers sized for the same suspension track. Of course, an operable nonlinear edge shape may also undulate in some fashion beyond the extra width portion, partially to reduce a portion of the overlapped section between louvers corresponding to a conventional overlapped section. However, a closed blind desirably will have at least a certain amount of overlap between adjacent louvers.

FIGS. 10 through 12 illustrate perpendicular light, indicated at 200, being variably obstructed by louver elements 202. As ladder structure 190 is manipulated to distort a box 204 in which a louver 202 is supported, the louver elements 202 block increasing amounts of perpendicular light 200.

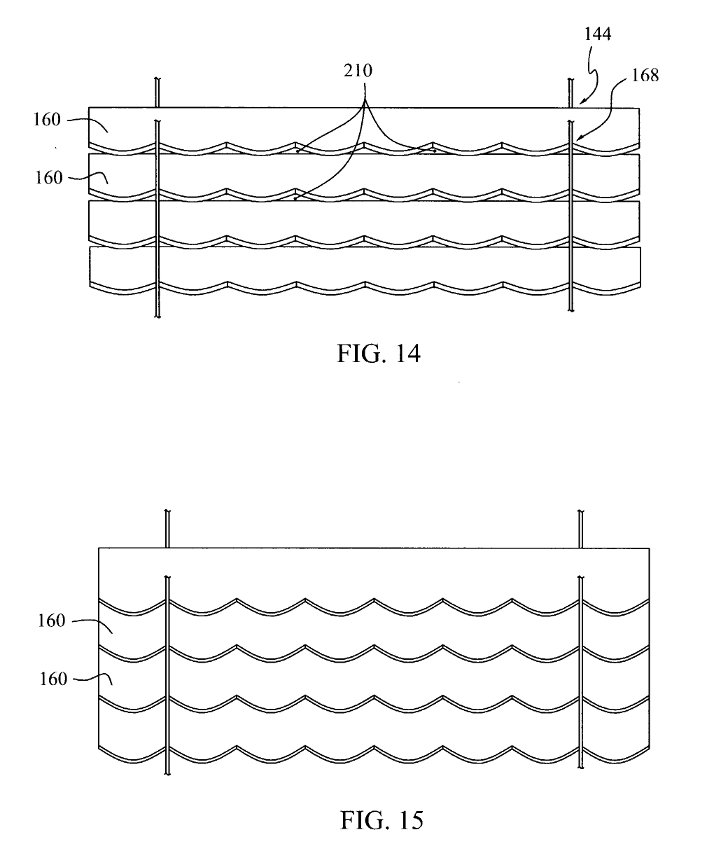

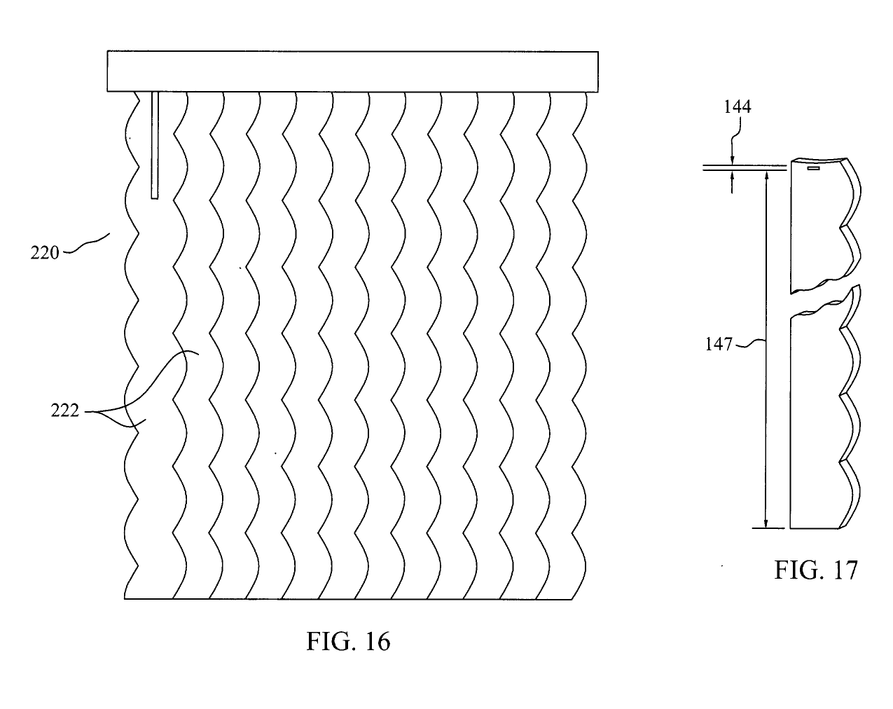

FIGS. 13 through 15 illustrate a plurality of improved louvers 160 in various rotation orientations. FIG. 13 illustrates louvers 160 in a fully open rotation orientation, permitting passage of light 200 through a plurality of apertures or slots 208. In FIG. 14, apertures 208 are subdivided to form a plurality of apertures 210. Apertures 210 are formed by a portion of louvers 160 that overlap their adjacent below-positioned louver 160 at a lesser rotation angle than a conventional louver 101. Apertures 210 are variable in size, with their size and conformation depending on rotation orientation of the louvers 160. The variation in size of apertures 210 causes a corresponding beneficial variation in form and pattern of transmitted light and shadow cast into a room equipped with an embodiment of the invention. At least certain of apertures 210 are formed spaced apart from interface portions 168 at suspension locations 144. FIG. 15 illustrates louvers 160 rotated to a third rotation orientation, which blocks passage of perpendicular light 200.

FIG. 16 illustrates an embodiment of a vertical blind, generally indicated at 220, having vertically disposed louver elements 222 constructed according to the present invention. FIG. 17 illustrates one construction of an alternative vertical louver element 224 according to the present invention. Louver 224 includes suspension portion 144 and a blocking portion 147.

Louvers according to the present invention can be manufactured by stamping individual louvers from sheet stock, pultruding or forming from ribbon stock cut to length, and/or by cutting, routing, milling or performing some other machining operation to form a decorative edge structure. Materials from which louvers may be made can nonexclusively include plastic, metal, wood, and any other material suitable for use in a conventional louver.

While the invention has been described in particular with reference to certain illustrated embodiments, such is not intended to limit the scope of the invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to modify transmission of light through an area, comprising:
a first plurality of louvers, each of said louvers comprising a blocking portion and an interface portion, said interface portion consisting of louver edge structure, said edge structure being formed in at least a first edge of said louvers and operable to maintain an alignment of said louvers in said apparatus; and
a suspension mechanism adapted to hold said louvers at said interface portion and operable to rotate said louvers between a first, a second, and a third orientation, said plurality of louvers being disposable in approximately parallel combination by structure of said suspension mechanism substantially to cover said area;
wherein:
at said first orientation, said blocking portion of said louvers blocks direct transmission of light perpendicular to said area therethrough; and
at said second orientation, at least one aperture, permitting direct transmission of light perpendicular to said area therethrough, is formed between adjacent two of said louvers and is disposed spaced apart from said interface portion.

2. The apparatus of claim 1, wherein:
at said third orientation, a slot, permiting direct transmission of light perpendicular to said area therethrough, is formed between adjacent louvers.

3. The apparatus of claim 1, wherein:
said louvers each comprise first and second edges between opposite ends and, at said first orientation, a portion of a first edge of a first louver overlaps a portion of a second edge of a second louver that is adjacent to said first louver; and
a portion of said first edge of said first louver element is nonlinear, whereby, in combination with said second edge of said second louver, to form said at least one aperture when said first louver and said second louver are rotated to said second orientation.

4. The apparatus of claim 1, wherein:
at said second orientation, a plurality of apertures are formed between adjacent said blocking portions and spaced apart from said interface portions.

5. The apparatus of claim 4, said first edge comprising an undulating portion.

6. The apparatus of claim 4, said first edge comprising a scalloped portion.

7. The apparatus of claim 4, said first edge comprising an offset block portion.

8. The apparatus of claim 1, at least one said louver further comprising edge structure disposed on a second edge for engagement with suspension structure of said suspension mechanism to help maintain an alignment of said at least one louver with respect to said suspension structure.

9. The apparatus of claim 1, said louvers being arranged for generally horizontal deployment below said mechanism.

10. An improved decorative privacy-type louver for use in a blind, said louver comprising:
first and second edges spanning between first and second ends, said edges and said ends circumscribing at least one blocking portion and a plurality of suspension portions;
a plurality of retaining interfaces disposed at a plurality of said suspension portions and consisting of louver edge structure, said edge structure being carried by at least said first edge and being operable to create a structural interference whereby to maintain an alignment of said louver with respect to suspension structure;
wherein:
said first edge comprises a nonlinear portion disposed in said at least one blocking portion.

11. The louver of claim 10, wherein:
said first edge comprises one single continuous arc between said first end and a closest suspension portion.

12. The louver of claim 11, wherein:
said closest suspension portion is disposed between about 2½ and about 7½ inches inboard from said first edge

13. The louver of claim 11, said first edge being defined by a plurality of similar-sized circular-section arcs, adjacent of said arcs intersecting at a cusp, each said cusp defining a minimum width of said louver.

14. The louver of claim 11, further comprising a notch disposed on said second edge at a suspension portion.

15. The louver of claim 13, a maximum louver width being about 2½ inches and a minimum louver width being about 2 inches.

16. The combination of a plurality of louvers according to claim 10, said louvers being disposed substantially in parallel and suspended from a mechanism operable to rotate said plurality of louvers between first and second orientations, said first orientation blocking perpendicular light, said second orientation forming at least one aperture between at least two adjacent louvers for passage of perpendicular light therethrough, said at least one aperture being spaced apart from said suspension portions.

17. The combination of claim 16, each of said plurality of louvers having a maximum width that is an oversized width compared to a rung size of suspension ladder structure, said oversized width carrying decorative edge structure.

18. A blind, comprising:
a suspension mechanism adapted for attachment of said blind to structure of a building;
first and second horizontally spaced apart suspension tracks depending from said suspension mechanism, each said track comprising a plurality of vertically spaced apart rungs between front and rear rails, each said rung having approximately the same length;
a plurality of louvers arranged for generally horizontal dependency below said suspension mechanism, each louver being supported at a plurality of interface zones by a plurality of said rungs, said louvers each comprising a maximum width sized greater than said length of said rungs, and first and second edges oriented in a length direction, said louvers being rotatably arranged in substantially parallel alignment to permit forming an overlap between at least portions of adjacent first and second edges; wherein:
a said first edge of at least one of said louvers comprises a decorative edge portion spaced apart from said interface zone, a path along said decorative edge portion comprising a portion being oriented nonparallel to said length direction;
a portion of said decorative edge portion forming a localized area of reduced width in a said louver at a said interface zone, said localized area of reduced width being operable to form a structural interference with rail structure of a said track, said interference being operable to resist misalignment of said louver with respect to a said track.

19. The blind of claim 18, further comprising:
a plurality of decorative louvers, each decorative louver having a repeating louver edge pattern disposed on an inside edge of said decorative louver, said pattern having a pattern length that is longer than about 1½ times said reduced louver width.

20. The blind of claim 19, wherein:
said edge pattern of said decorative louvers comprises a nonlinear edge shape formed in about ½ inch louver width additional to said reduced louver width.
